(19) United States
(12) Patent Application Publication
(10) Pub. No.: US 2009/0174343 A1
(43) Pub. Date: Jul. 9, 2009

(54) Multiple LED Driver

(76) Inventors: Michael Lenz, Zorneding (DE); Nicola Macri, Munich (DE); Reiner Elmers, Taufkirchen (DE); Adam Opielka, Greisstaett (DE)

Correspondence Address: SLATER & MATSIL LLP, 17950 PRESTON ROAD, SUITE 1000, DALLAS, TX, 75252, US

(21) Appl. No.: 11/971,827

(22) Filed: Jan. 9, 2008

(51) Int. Cl. H05B 37/00

(52) U.S. Cl. 315/292; 315/297

(57) ABSTRACT

A driver circuit driving at least a first light emitting diode. The driver circuit includes: a first bypass current source coupled in parallel to the first light emitting diode. The first bypass current source and the first light emitting diode form a first parallel circuit. A main current source is coupled in series with the first parallel circuit. A first regulator unit is configured to control a first bypass current of the first bypass current source.

### TECHNICAL FIELD

Embodiments of the invention relate to the field of driver circuits for light emitting diodes (LEDs), especially for battery driven applications.

### BACKGROUND

Light emitting diodes (LEDs) are increasingly utilized for illumination since high power LEDs are available at low costs. In order to provide a constant light intensity, light emitting diodes have to be driven with a constant load current.

For driving a single LED or a plurality of LEDs with a constant current, special driver circuits have been developed. In battery driven illumination applications, especially in automotive applications, the supply voltage provided by the (automotive) battery is much higher than the voltage drop across a light emitting diode. As a consequence most of the power is dissipated in the driver circuit, especially in current sources and series resistors of the LEDs. Connecting several LEDs in series reduces the power dissipation in the driver circuit. For example, up to 5 LEDs connected in series each having a typical forward voltage of 2.1 V may be driven by a 12 V automotive battery. However, the brightness of the LEDs can not be individually controlled which is particularly desirable when using LEDs of different colors for additive mixing of colors.

A Multi-Color LED circuit often comprises a red LED, a green LED, a blue LED, and optionally a white LED, where the brightness of each of the LEDs has to be individually controllable for generating an arbitrary color in the visible spectrum.

There is a need for a novel low power loss LED driver circuit that enables the individual brightness control of the connected LEDs.

### SUMMARY OF THE INVENTION

A first example of the invention relates to a driver circuit for driving at least a first array of light emitting diodes. The driver circuit comprises: a first bypass current source connected in parallel to the first light emitting diode, the first bypass current source and the first light emitting diode forming a first parallel circuit; a main current source connected in series to the first parallel circuit; and a first regulator unit configured to control a first bypass current of the first bypass current source.

According to another example of the invention the driver circuit comprises: a plurality of bypass current sources forming a chain of current sources, each current sources driving a bypass current; a main current source connected in series to the chain of current sources; a plurality of regulator units, each connected to a corresponding bypass current source and configured to control the bypass current of the respective bypass current source; a plurality of terminals for connecting an array of light emitting diodes of a plurality of arrays of light emitting diodes in parallel to each bypass current source.

A further example of the invention relates to an illumination device, that comprises: at least a first and a second array of light emitting diodes; at least two bypass current sources each providing a bypass current, where each light emitting diode has one bypass current source connected in parallel; a main current source, where the main current source and all bypass current sources are connected in series; and at least two regulator units, where each regulator unit is connected to a respective bypass current source and configured to control the bypass current of the respective bypass current source.

### BRIEF DESCRIPTION OF THE DRAWINGS

Embodiments of the invention can be better understood with reference to the following drawings and description. The components in the figures are not necessarily to scale, instead emphasis being placed upon illustrating the principles of the invention. Moreover, in the figures, like reference numerals designate corresponding parts. In the drawings:

FIG. 1 illustrates a known LED driver circuit;

FIG. 2 illustrates a novel LED driver circuit as a first example of the present invention;

FIG. 3 illustrates another exemplary LED driver circuit where the load currents passing through the LEDs are modulated;

FIG. 4 illustrates another LED driver circuit as a further example of the present invention; and

FIGS. 5A, 5B and 5C, collectively as FIG. 5, illustrate examples of arrays of light emitting diodes.

### DETAILED DESCRIPTION OF ILLUSTRATIVE EMBODIMENTS

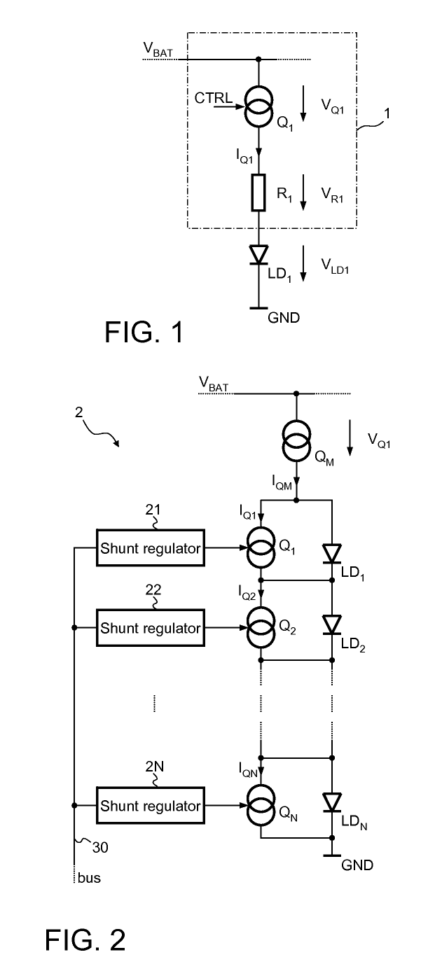

FIG. 1 illustrates a commonly used driver circuit 1 for driving a light emitting diode LD₁. The driver circuit 1 comprises a current source Q₁ and an optional series resistor R₁ both connected in series to the light emitting diode LD₁. In the present example, the current source Q₁ is supplied from a first supply potential V_{BAT} that is provided, for example, by an automotive battery. The cathode of the light emitting diode LD₁ is connected to a reference supply terminal providing a reference supply potential, e.g., ground potential GND. However, the positions of the diode LD₁, the optional resistor R₁, and the current source Q₁ may be interchanged arbitrarily.

In order to adjust the brightness of the light emitting diode LD₁, the current source Q₁ may be controllable, that is, the load current I_{Q1} passing through the current source Q₁ is dependent on a control signal CTRL received by the current source Q₁.

The power losses P_{D} dissipated in the driver circuit may be calculated according to the following equation, provided that no resistor is present:

P_{D}=I_{Q1}(V_{BAT}—V_{LD1}), (1a)

wherein V_{LD1} denotes the forward voltage drop across the light emitting diode LD₁.

If series resistor R1 is used, the power losses are:

P_{D}=I_{Q1}(V_{BAT}—I_{Q1}·R₁−V_{LD1}), (1b).

Resistor R₁ is helpful in order to reduce the power losses the current source Q₁ has to handle. R₁ takes over a part of the overall power losses and therefore may help to avoid a “hot spot” in the current source Q₁.

Since battery voltages V_{BAT} are typically much higher than the forward voltage V_{LD1} of the light emitting diode, power losses in the driver circuit are rather high. This entails increased efforts for cooling of the driver circuit and, in automotive applications, increased power consumption.

When driving more than one LED and if the brightness of each LED should be controllable, then a separate driver circuit 1 according to FIG. 1 may be used for each single diode, thus the power loss P_{D} as calculated according to equation 1 multiplicates by the number of LEDs.

FIG. 2 illustrates a novel driver circuit 2 for driving a plurality of arrays of light emitting diodes LD₁, LD₂, . . . LD_{N}. However, the driver circuit 2 of FIG. 2 may be usefully employed for driving at least two arrays of light emitting diodes LD₁, LD₂, . . . , LD_{N} connected in series. The driver circuit comprises a main current source Q_{M} providing a main current I_{QM}. A plurality of bypass current sources Q₁, Q₂ . . . , Q_{N} are connected in series to the main current source Q_{M} and have terminals for connecting an array of light emitting diodes in parallel to each bypass current source Q₁, Q₂ . . . , Q_{N}. Each bypass current source Q₁, Q₂ . . . , Q_{N} drives a bypass current I_{Q1}, IQ₂ . . . , I_{QN}.

In the circuit of FIG. 2 each of the arrays of light emitting diodes comprises one light emitting diode, only. However, instead of only one diode of a serial circuit including several light emitting diodes in series, a parallel circuit including several light emitting diodes connected in parallel, or a parallel-serial circuit including several serial circuits with light emitting connected in parallel, may be connected in parallel to each of the bypass current sources Q₁, Q₂ . . . , Q_{N} as well.

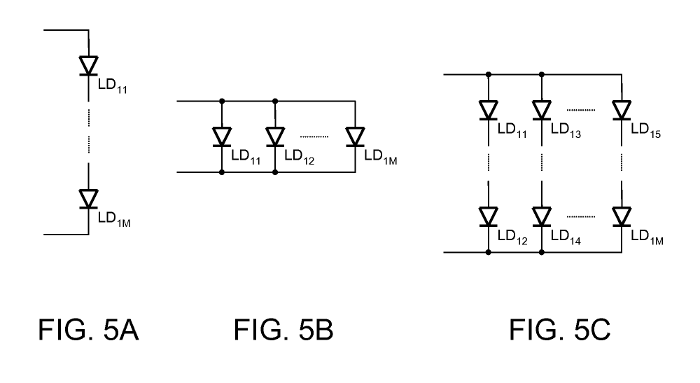

Examples of such arrays are shown in FIG. 5 where FIG. 5A shows an array that includes a series circuit with several light emitting diodes LD₁₁, . . . , LD_{1M}, FIG. 5B shows an array that includes a parallel circuit with several light emitting diodes LD₁₁, . . . , LD_{1M}, and FIG. 5C shows a parallel-serial circuit.

The main current source Q_{M} is supplied by a first supply potential V_{BAT}, that is, for example, provided by an automotive battery. It should be noted that supply voltage V_{BAT} fed to the driver circuit 2 should be selected to be high enough for supplying the number of diodes LD₁, LD₂, . . . LD_{N} that are connected in series. In the circuit of FIG. 2 each bypass current source Q₁, Q₂ . . . , Q_{N} and the respective light emitting diode LD₁, LD₂, . . . LD_{N} form a parallel circuit, wherein all these parallel circuits are connected in series between the main current source Q_{M} and a supply terminal providing a reference supply potential, e.g., ground potential GND.

One regulator unit 21, 22, . . . 2N is connected to each bypass current source Q₁, Q₂ . . . , Q_{N} and is configured to control the bypass current I_{Q1}, I_{Q2} . . . , I_{QN} passing through the respective bypass current source Q₁, Q₂ . . . , Q_{N}. As a result, the effective load current I_{LD1} that passes through a certain light emitting diode LD₁ of the plurality of light emitting diodes equals to the difference between the main current I_{QM} and the respective bypass current I_{Q1}, that is:

I_{LDi}=I_{QM}−I_{Qi}, (2)

whereby i is an index ranging from 1 to N denoting the number of the bypass current source Qᵢ with the bypass current I_{Qi} and the light emitting diode LDᵢ with the load current I_{LDi}.

By means of the regulator units 21, 22, . . . , 2N the brightness of each single LED LDᵢ may be adjusted to a desired value by appropriately controlling the bypass currents I_{Qi} and thus the load currents I_{LDi}. Each regulator unit 21, 22, . . . , 2N may comprise a digitally addressable bus interface, for example a serial bus interface for connecting a serial bus 30. The desired current or brightness value may be received from the bus 30 as a binary word. If desired brightness values are received from the bus 30, the regulator units 21, 22, . . . , 2N may comprise a calibration table for converting a received desired brightness values to a desired load current value I_{Di} for the respective light emitting diode LDᵢ.

After the desired load current value I_{Di} has been found the bypass current I_{Qi} of the respective bypass current source is set to drive a bypass current I_{Qi}=I_{M}−I_{Di}. However the bypass current sources Qᵢ do not necessarily have to drive continuous bypass currents I_{Qi}. The regulator units 21, 22, . . . , 2N are often easier to implement if the bypass current sources Qᵢ are controlled by a pulsed control signal resulting in pulsed bypass currents I_{Qi} and in pulsed load currents I_{LDi} whose average value equals to the desired load current I_{Di}. For this purpose each regulator unit 21, 22, . . . , 2N may comprise a modulator for providing a pulsed control signal, e.g., a pulse-width modulated, a pulse-frequency modulated, or a pulse-density modulated control signal for controlling the bypass current sources Qᵢ. In this case the bypass currents I_{Qi} are switched on and off according to the pulsed control signal supplied to the bypass current sources Qᵢ by the respective regulator unit.

Summarizing the above, bypass current sources Qᵢ may be controlled to either provide a varying current I_{Qi} that ranges from zero to a given maximum value dependent on a respective control signal provided by the corresponding shunt regulator. The maximum value in this connection may correspond to the current provided by main current source Q_{M}, where in this case the current through an array is zero if the current provided by the corresponding bypass current source has its maximum value. Alternatively, bypass current sources Qᵢ may be controlled in pulsed fashion. The bypass current I_{Qi} is in this case either zero or a given maximum value.

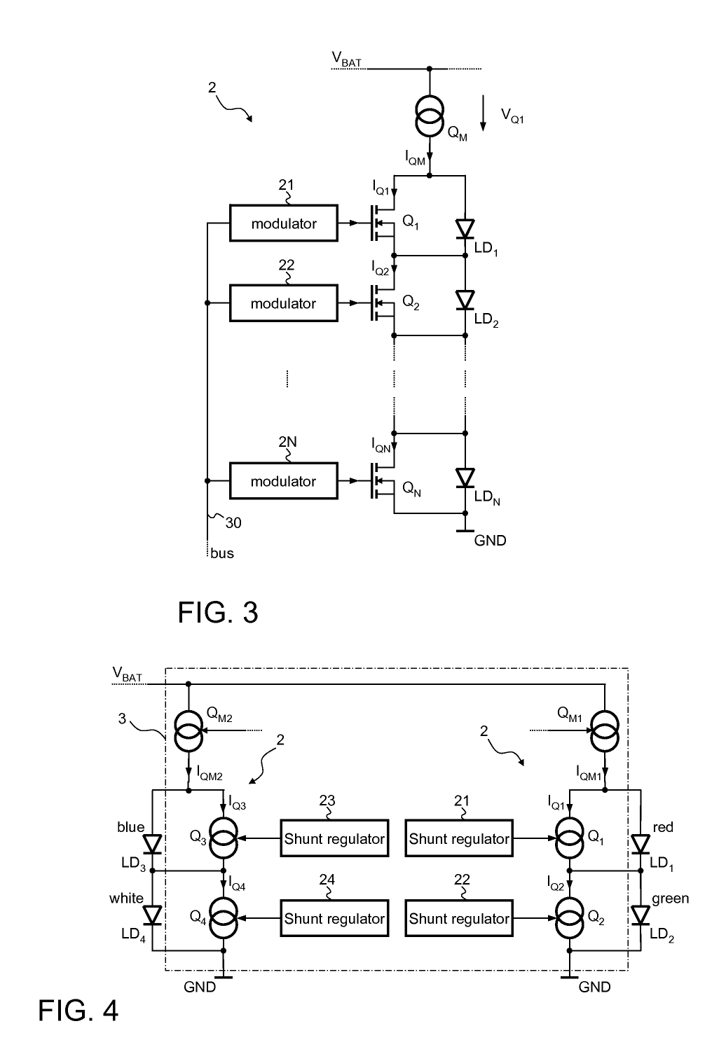

FIG. 3 illustrates an example where the bypass currents I_{QI} and the load currents I_{LDi} are modulated by means of the regulator units 21, 22, . . . , 2N that, in the present case, each comprise a modulator, e.g., a pulse width modulator, a pulse frequency modulator or a pulse density modulator. In this case simple semiconductor switches, e.g., MOSFETs, may be employed as bypass current sources Qᵢ that are switched on and off dependent on output signals provided by the regulator units 21, 22, . . . , 2N. Thereby, the property of field effect transistors to operate as voltage controlled current sources is utilized. In this arrangement a bypass current I_{Qi} is either zero, if the MOSFET Qᵢ that controls the bypass current is switched off, or has a maximum value corresponding to the current provided by the main current source Q_{M}, if the MOSFET Qᵢ that controls the bypass current is switched on. Except for the bypass current sources, the example of FIG. 3 is identical to the example of FIG. 2.

Instead of switching MOSFETs Qᵢ on and off, these MOSFET may either be controlled in an analog manner, thereby varying the bypass currents I_{Qi} between zero and a maximum value that corresponds to the current provided by the main current source Q_{M}.

In multi-color applications, for example, an illumination device comprising a red LED LD₁, a green LED LD₂, and a blue LED LD₃, and a driver circuit 2 as shown in FIG. 3, the color generated by mixing the light of the different LEDs may be adjusted by appropriately adjusting the brightness of each single LED LD₁, LD₂, LD₃ by means of the regulator units 21, 22, . . . , 2N. In contrast, the overall brightness may be adjusted by varying the main current I_{QM}.

In the following paragraph the losses due to power dissipation of the present example are compared to the power losses occurring in the known driver circuit of FIG. 1. The forward voltage V_{LD1} of the red LED LD₁ is approximately 2.5 V, the forward voltages V_{LD1}, V_{LD2} of the green LED LD₂ and the blue LED LD₃ are approximately 3.5 V at a main current I_{M} of 50 mA. For a driver circuit as shown in FIG. 3 the total power dissipation P_{D} calculates as follows (V_{BAT}=18V):

PD=(V_{BAT}−V_{LD1}−V_{LD3}−V_{LD3})I_{M}=0.425 W, (3)

wherein for three driver circuits according to FIG. 1 the power losses are

P_{D}=I_{Q1}(V_{BAT}−V_{LD1})+I_{Q2}(V_{BAT}−V_{LD2})+I_{Q3}(V_{BAT}−V_{LD3})=2.225 W, (4)

provided that I_{Q1}=I_{Q2}=I_{Q3}=50 mA, and that a duty cycle of the control signals controlling current sources Qᵢ is 1. The total voltage drop across the LEDs LD₁, LD₂, and LD₃ is about 9.5 V and the minimum voltage drop across the main current source Q_{M} is typically about 0.5 V, so that a minimum of V_{BAT}=10 V is required that the driver circuit 2 is able to operate properly.

FIG. 4 illustrates a further example of an embodiment of the present invention. This example is especially useful for low supply voltages V_{BAT}, in particular for supply voltages down to 10 V. In this example two driver circuits 2 as depicted in FIG. 2 are used, each driving only two LEDs LD₁, LD₂, and LD₃ and LD₄ respectively. The overall driver circuit is denoted as driver circuit 3. The present driver circuit 3 and the connected LEDs LD₁, LD₂, LD₃, and LD₄ form a multi-color illumination device, where LED LD₁ is a red LED, LED LD₂ is a green LED, LED LD₃ is a blue LED, and LED LD₄ is a white LED. As mentioned above the hue of the total color resulting from an additive color mixture of the light emitted by the four LEDs may be adjusted by appropriately controlling the bypass current sources Q₁, Q₂, Q₃ corresponding to the red, the green, and the blue LED respectively. The overall brightness may be varied either by varying the two main currents I_{M1} and I_{M2} or by adjusting the brightness of the white LED by means of the respective regulator unit 24.

One advantage of the driver circuits as explained in FIGS. 2 to 4 is that a DC current flows in a supply between a terminal for supply potential and the main current source Qₘ. No electromagnetic interferences may therefore result from the current flowing through the supply line which, e.g., in automotive applications, may have a length of up to one meter or more.

What is claimed is:

1. A driver circuit for driving at least a first array of light emitting diodes, the driver circuit comprising:
a first bypass current source coupled in parallel to the first array, the first bypass current source and the first array forming a first parallel circuit;
a main current source coupled in series to the first parallel circuit; and
a first regulator unit configured to control a first bypass current of the first bypass current source.

2. The driver circuit of claim 1 further comprising:
a second bypass current source coupled in parallel to a second array of light emitting diodes, the second bypass current source and the second array forming a second parallel circuit that is coupled in series with the first parallel circuit; and
a second regulator unit configured to control a second bypass current of the second bypass current source.

3. The driver circuit of claim 1, wherein the first regulator unit comprises an interface for connecting to a data bus and is configured for setting the first bypass current according to a desired value received from the data bus.

4. The driver circuit of claim 3, wherein the first regulator unit is configured to switch the first bypass current source on and off, such that an average value of the first bypass current equals a desired value received from the data bus.

5. The driver circuit of claim 4, wherein the regulator unit is configured to switch the first bypass current source on and off, such that the bypass current is pulse width modulated, pulse frequency modulated, or pulse density modulated.

6. The driver circuit of claim 1, wherein the first array of light emitting diodes comprises only one light emitting diode.

7. A driver circuit comprising:
a plurality of bypass current sources forming a chain of current sources, each current source driving a bypass current;
a main current source connected in series to the chain of current sources;
a plurality of regulator units, each regulator unit coupled to a corresponding bypass current source and configured to control the bypass current of the corresponding bypass current source; and
a plurality of terminals for coupling an array of light emitting diodes in parallel with each bypass current source.

8. The driver circuit of claim 7, wherein each regulator unit comprises an interface for coupling to a data bus and is configured for setting the bypass current of the corresponding bypass current source based on a desired value received from the data bus.

9. The driver circuit of claim 8, wherein each regulator unit is configured to switch the corresponding bypass current source on and off, such that an average value of the bypass current equals a desired value received from the data bus.

10. The driver circuit of claim 9, wherein the regulator unit is configured to switch the corresponding bypass current source on and off, such that the bypass current is pulse width modulated, pulse frequency modulated, or pulse density modulated.

11. The driver circuit of claim 7, wherein each terminal is coupled to only a single light emitting diode.

12. An illumination device comprising:
at least a first and a second array of light emitting diodes;
at least two bypass current sources each providing a bypass current, wherein each array of light emitting diodes has one bypass current source coupled in parallel;
a main current source, wherein the main current source and all bypass current sources are coupled in series; and
at least two regulator units, wherein each regulator unit is coupled to a respective bypass current source and configured to control the bypass current of the respective bypass current source.

13. The illumination device of claim 12, wherein each regulator unit comprises an interface for connecting to a data bus and is configured for setting the bypass current of the respective bypass current source based on a desired value received from the data bus.

14. The illumination device of claim 13, wherein each regulator unit is configured to switch the respective bypass current source on and off, such that an average value of the bypass current equals the desired value received from the data bus.

15. The illumination device of claim 14, wherein the regulator unit is configured to switch the respective bypass current source on and off, such that the bypass current is pulse width modulated, pulse frequency modulated, or pulse density modulated.

16. The illumination device of claim 12, wherein the light emitting diodes comprise at least one white light emitting diode.

17. The illumination device of claim 12, wherein a main current of the main current source is adjustable.

18. The driver circuit of claim 12, wherein the first array and the second array of light emitting diodes each comprise only one light emitting diode.
